(19) United States
(12) Patent Application Publication
(10) Pub. No.: US 2012/0158776 A1
(43) Pub. Date: Jun. 21, 2012

(54) SYSTEM AND METHOD FOR CAPTURING, PROCESSING AND REPLAYING CONTENT

(75) Inventors: Maurice Alan Howard, Farmington Hills, MI (US); Michael Allen Vinson, Akron, OH (US); Michael Allen Brown, Wauwatosa, WI (US); Kerri Maureen Korth, Milwaukee, WI (US); David Shauncey Simpson, Lyndhurst, OH (US); Douglas R. Wylie, Eastlake, OH (US); James J. O'Hare, Euclid, OH (US); Richard C. Ryan, Hartland, WI (US); Fredrick M. Discenzo, Brecksville, OH (US)

(73) Assignee: ROCKWELL SOFTWARE INC., West Allis, WI (US)

(21) Appl. No.: 13/332,209

(22) Filed: Dec. 20, 2011

Related U.S. Application Data
(63) Continuation of application No. 10/097,584, filed on Mar. 13, 2002, now abandoned.
(60) Provisional application No. 60/338,268, filed on Nov. 9, 2001.
(60) Provisional application No. 60/323,837, filed on Sep. 20, 2001.

(51) Int. Cl. G06F 17/30

(52) U.S. Cl. 707/769; 707/758; 707/E17.009; 707/E17.014

(57) ABSTRACT

A system and method for capturing and replaying content is provided. The invention includes a base content source, a user system and resources. The invention provides for a knowledge embedding component to provide information associated with the base content. Further, a capturing component captures base content and/or information related to the base content for replay. The invention further provides for a personalization component to filter base content and/or information associated with base content based on a type of user, type of information, historical information and/or personal information.

### CROSS-REFERENCE TO RELATED APPLICATIONS

This application is a continuation of U.S. patent application Ser. No. 10/097,584, filed Mar. 13, 2002 entitled SYSTEM AND METHOD FOR CAPTURING, PROCESSING AND REPLAYING CONTENT, which claims the benefit of U.S. Provisional Application Ser. No. 60/338,268 entitled SYSTEM AND METHOD FOR CAPTURING, PROCESSING AND REPLAYING CONTENT, filed on Nov. 9, 2001, and U.S. Provisional Application Ser. No. 60/323,837 entitled SYSTEM AND METHOD FOR CAPTURING AND REPLAYING CONTENT, filed on Sep. 20, 2001.

### TECHNICAL FIELD

The present invention relates to the field of systems for multi-media content capturing, processing and replaying.

### BACKGROUND OF THE INVENTION

Human interaction for the exchange of ideas is necessary to facilitate business, education, and countless other endeavors. With ever increasing globalization, it has become more difficult for those persons necessary to develop a collaborative effort to be present in the same physical location, thus leading to delays in the process. Additionally, documentation related to the collaborative effort and, especially the human thought process, has conventionally been flawed—each person in attendance at a meeting having a different recollection of the events that unfolded at the meeting.

Further, the availability of resources such as text document(s), graphical image(s), audio and/or video information via computer system, and more particularly, the Internet has lead to an increase in the amount of educational resource(s) available. However, accessing these resources in an appropriate manner has proved difficult.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

The present invention relates to a system and method for capturing, processing and replaying multi-media content. According to an aspect of the present invention, a system is provided having a user system coupled to one or more base content source(s). The base content source includes base content which can be an output of a white board device, a web page, a graphical image, a text document, an audio file, an audio stream, a video file, a video stream and/or a computer system.

The user system comprises output device(s), a capturing component, a knowledge embedding component and a communications component. Further, the user system can optionally include input device(s), a personalization component, a content analyzing component and/or a search engine system. The user system can provide access to resources via the communications component.

Utilizing the input device(s), a user can modify the base content and/or access information related to the base content provided by the knowledge embedding component. The knowledge embedding component can provide access to web page(s), graphical image(s), text document(s), audio file(s), audio stream(s), video file(s), video stream(s) and/or computer system(s) related to the base content. The personalization component can filter the base content and/or information related to the base content provided by the knowledge embedding component based, for example, upon a type of user, type of information, goal, context, historical information and/or personal information. The analyzing component can analyze the base content and provide information for use by the knowledge embedding component. The search engine system can perform a search (e.g., via the Internet) based at least in part upon information obtained from the content analyzing component and provide the search results to the knowledge embedding component.

Another aspect of the present invention provides for the system to include a user access component adapted to determine an amount of the base content a user is permitted to modify.

Yet other aspects of the present invention provides for a method for capturing content, a computer readable medium having computer executable instructions for capturing content and a data packet adapted to be transmitted between two or more computer processes comprising identification of resources related to base content based at least in part upon information stored in a knowledge base.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 is a schematic block diagram of a content capturing system in accordance with an aspect of the present invention.

FIG. 2 is a simulated screen shot of a user interface in accordance with an aspect of the present invention.

FIG. 3 is a schematic block diagram of a content capturing system in accordance with an aspect of the present invention.

FIG. 4 is a block diagram of a personalizing component in accordance with as aspect of the present invention.

FIG. 5 is a block diagram of a system for providing embedded knowledge in accordance with an aspect of the present invention.

FIG. 6 is a flow chart illustrating a methodology for capturing content in accordance with an aspect of the present invention.

FIG. 7A is a simulated screen shot of a user interface in accordance with an aspect of the present invention.

FIG. 7B is a simulated screen shot of a user interface in accordance with an aspect of the present invention.

FIG. 7C is a simulated screen shot of a user interface in accordance with an aspect of the present invention.

FIG. 7D is a simulated screen shot of a user interface in accordance with an aspect of the present invention.

FIG. 7E is a simulated screen shot of a user interface in accordance with an aspect of the present invention.

FIG. 7F is a simulated screen shot of a user interface in accordance with an aspect of the present invention.

FIG. 8A is a simulated screen shot of a user interface in accordance with an aspect of the present invention.

FIG. 8B is a simulated screen shot of a user interface in accordance with an aspect of the present invention.

FIG. 8C is a simulated screen shot of a user interface in accordance with an aspect of the present invention.

FIG. 8D is a simulated screen shot of a user interface in accordance with an aspect of the present invention.

FIG. 9A is a simulated screen shot of a user interface in accordance with an aspect of the present invention.

FIG. 9B is a simulated screen shot of a user interface in accordance with an aspect of the present invention.

FIG. 9C is a simulated screen shot of a user interface in accordance with an aspect of the present invention.

FIG. 10 is a simulated screen shot of a user interface in accordance with an aspect of the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident to one skilled in the art that the present invention may be practiced without these specific details. In other instances, well-known structures and devices are shown in block diagram form in order to facilitate description of the present invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component.

Further, the term “content” refers to representation(s) of information in one or more formats, including, but not limited to, textual document(s), graphical image(s), audio file(s), streaming audio, video file(s), streaming video, and/or computer system(s). Additionally, “content” can refer to a combination of representation(s) of information in various formats.

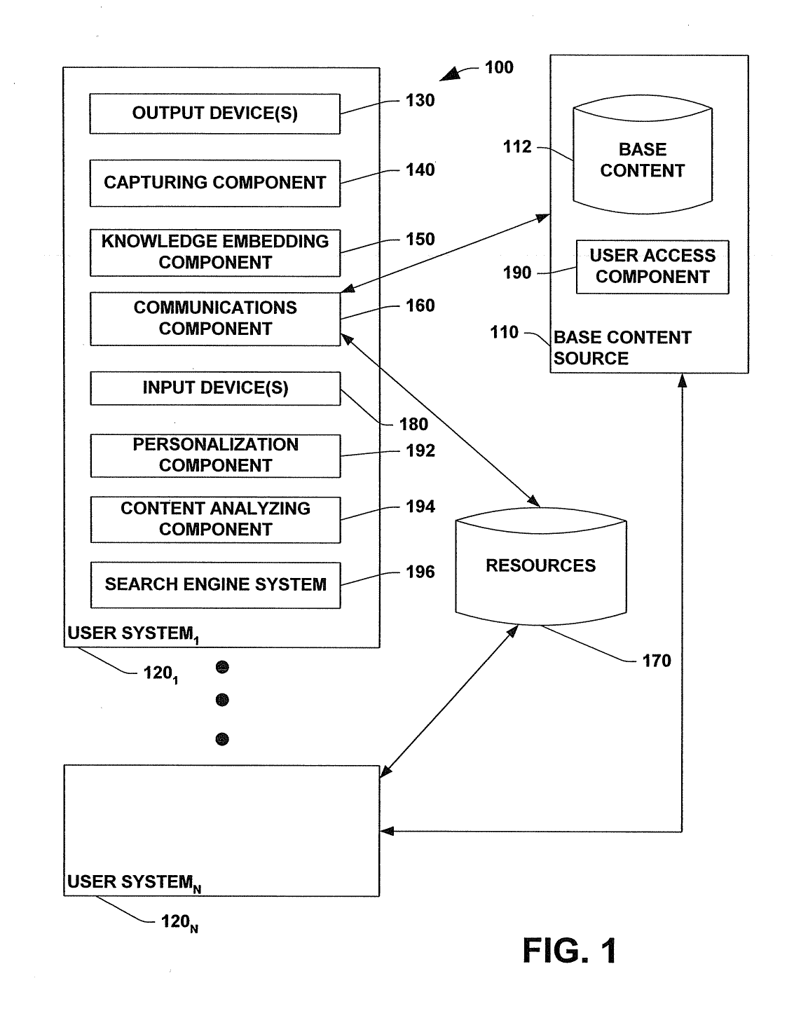

Referring to FIG. 1, a system for capturing content 100 is illustrated. The system 100 can be used for a plurality of functions. For instance, the system 100 can simply present information in a particular topic area to brief the user or to provide the user an update of the topic; the system 100 can be used as a tutorial in which information is presented to the user and the user is instructed with specific (measurable) learning objectives; the system 100 can facilitate problem solving in an individual or group environment, for example, by solving a specific problem, retrieving specific information about a problem, answering questions, and making decisions; and/or the system 100 can be used in an exploratory manner, for example, searching for interesting facts, computing statistics from searches, and searching for new information or capabilities. The system 100 includes a base content source 110, resources 170 and a first user system 120₁ through an Nth user system 120_{N}, N being an integer greater to or equal to one. The user systems 120₁ through 120_{N} can be referred to collectively as the user system 120.

The base content source 110 includes base content 112 (e.g., textual document(s), graphical image(s), audio file(s), streaming audio, video file(s), streaming video, and/or computer system(s)) related to one or a plurality of task(s) (e.g., collaborative meeting, brainstorming session, classroom instruction and/or sales presentation). For example, the base content 112 can be an input from a white-board, a web page, a graphical image, a text document, an audio file, an audio stream, a video file, a video stream, and/or computer system

Optionally, the system 100 can include a user access component 190. The user access component 190 is adapted to determine an amount of the base content 112 a user of the user system 120 is permitted to modify. While the user access component 190 is depicted in FIG. 1 as part of the base content source 110, the user access component 190 can alternatively be part of the user system 120, a remote system (not shown) or a combination thereof.

For example, users of the system 100 can be assigned hierarchical rights to modify the base content 112. A particular user can be assigned “observer status” allowing the user the right merely to observe, but not change, the base content 112. Other users can be assigned modification rights based upon a type of user, for example, professor, teaching assistant and/or student. While a user assigned to the user type “student” could be given permission to modify base content 112, those hierarchically above the user, “professor” and/or “teaching assistant”, could block and/or modify any modification(s) by users designated as “student”. Further, users can be assigned modification rights based upon a type of base content—engineers allowed to modify technical information while sales persons only allowed to view technical information but change pricing information.

The resources 170 include information (e.g., web page, a graphical image, a text document, an audio file audio stream, a video file, a video stream, and/or computer system) related to the base content thus providing the opportunity for a user of the system 100 to gain further information related to the base content 112. The resources 170 can be available locally (e.g., within the user system 110 itself) and/or remotely (e.g., via a local area network and/or the Internet).

The user system 120 includes output device(s) 130, a capturing component 140, a knowledge embedding component 150 and a communications component 160. Optionally, the user system 120 can include input device(s) 180, a personalization component 190, a content analyzing component 194 and/or a search engine system 196.

The output device(s) 130 facilitate communication of base content 112 and/or information related to base content 112 (e.g., resources 170) to a user of the user system 120. For example, the output device(s) can be a computer monitor, a television screen, a printer, a personal digital assistant, a wireless telephone display and speaker(s).

The communications component 160 facilitates communication between (1) the user system 120 and the base content source 110 and/or (2) the user system 120 and the resources 170. The user system 120 and the base content source 110 and/or the user system 120 and the resources 170 can be operatively coupled via a network employing including, but not limited to, Ethernet (IEEE 802.3), Wireless Ethernet (IEEE 802.11), PPP (point-to-point protocol), point-to-multipoint short-range RF (Radio Frequency), WAP (Wireless Application Protocol), Bluetooth, IP, IPv6, TCP and User Datagram Protocol (UDP) an extranet, a shared private network and/or a backplane (e.g., in multi-processor integration system(s)). Additionally, the user system 120 and the base content source 110 and/or the user system 120 and the resources 170 can be directly coupled (e.g., via a parallel, serial link (USB) and/or an IR interface). Information exchanged between and among the user system 120 and the base content source 110 and/or the user system 120 and the resources 170 can be in a variety of formats and can include, but is not limited to, such technologies as ASCII text files, HTML, SHTML, VB Script, JAVA, CGI Script, JAVA Script, dynamic HTML, PPP, RPC, TELNET, TCP/IP, FTP, ASP, XML, PDF, EDI, WML, VRML as well as other formats.

The capturing component 140 stores the base content 112, information related to the base content 112 and/or information related to the base content 112 provided by the knowledge embedding component 150. For example, during a content capturing session, the capturing component 140 can store information related to changes in the base content 112 (e.g., user identifier, time stamp and/or date stamp). Further, at the end of a content capturing session, the capturing component 140 can permanently store information associated with the session, for example, by saving the information to a digital medium (e.g., diskette, CD, Bernoulli cartridge and/or hard disk). Information stored on the digital medium is then available for replay.

The knowledge embedding component 150 is adapted to provide information related to the base content 112. For example, the knowledge embedding component 150 can employ optical character recognition (OCR) of information written on a white board. Based at least in part upon the base content 112, the knowledge embedding component 150 can provide access to information related to the base content 112 (e.g., web page(s), graphical image(s), text document(s), audio file(s), audio stream(s), video file(s), video stream(s) and/or computer system(s). The knowledge embedding component 150 can utilize artificial intelligence (e.g., a neural network and/or an expert system) to facilitate identification of resources related to the base content 112. For example, in an instructional setting, a notation “The American Revolution” hand-written on a white board can be digitally recognized by the knowledge embedding component 150. Thereafter, the knowledge embedding component 150 can provide information to a user of the user system 110, such as making a copy of the Declaration of Independence available for the user to view and providing a hyper-link to an Internet web site related to the Boston tea party.

Optionally, the knowledge embedding component 150 can utilize artificial intelligence technique(s) to adaptively modify its behavior in order to identify resources related to the base content 112. For example, based upon historical usage of the system 100, the knowledge embedding component 150 can determine a likelihood that particular resource(s) will be useful to a user.

The input device(s) 180 can include but are not limited to a keyboard, a pointing device, such as a mouse, a microphone, an IR remote control, a joystick, a game pad, a personal digital assistant (PDA), kinematic sensor(s) (e.g., glove) and/or eye sensor(s) or the like. The input device(s) 180 facilitate a user modifying the base content 112 and/or accessing information related to the base content 112 provided by the knowledge embedding component 150. For example, in an instructional setting, student(s) located at remote physical location(s) can more fully participate in classroom discussions by modifying base content (e.g., white board presentation material(s)) and/or by selecting and accessing resources 170 (e.g., copy of the Declaration of Independence) related to the base content 112.

The personalization component 192 can filter base content 112 and/or information provided by the knowledge embedding component 150 (e.g., based upon a type of user, type of information, historical information and/or personal information). For example, the personalization component 190 can determine that based upon historical information a particular user does not desire to review base content in text form, but instead prefers to have the base content converted to audio format (e.g., for a sight-impaired user). Further, the personalization component 190 can filter out certain type(s) of information for a particular user and/or type of user (e.g., technical information filtered from a sales person).

The content analyzing component 194 can analyze the base content 112 and provide information for use by the knowledge embedding component 150. The content analyzing component 194 can utilize artificial intelligence and/or expert system techniques in order to facilitate presentation of suitable information by the knowledge embedding component 150 to a user. For example, utilizing artificial intelligence technique(s), the content analyzing component 194 can determine that a reference to “Bluetooth” is more likely related to wireless communications modalities rather than dentistry. Further, the content analyzing component 194 can utilize predictive technique(s) to facilitate presentation of information to a user. For example, based, at least in part, upon analysis of the base content 112, the content analyzing component 194 can predict the likelihood that particular resource(s) are suitable for a user. The content analyzing component 194 can also be employed to analyze trends in databases. For example, a database is accessed and partitioned, words and phrases contained in text documents of the partition are identified, and trends are discovered based upon the frequency with which the words and phrases appear.

The search engine system 196 is adapted to perform a search (e.g., locally, on the Internet and/or private network) based at least in part upon information obtained from the content analyzing component 194 and provide search results to the knowledge embedding component 150. Further, the search engine system 196 can be adapted to provide feedback to the knowledge embedding component 150, thus, facilitating adaptive changes to the knowledge embedding component 150.

The system 100, as described above, may be implemented as a collection of cooperating agents. Each functional element autonomously is directed at achieving it's local goal or function, but will also negotiate and adapt as needed to realize a larger, overall system objective.

Information management techniques, such as knowledge management, data mining, and case based reasoning can be included in the system. These techniques can be incorporated with the base content 112, the knowledge embedding component 150, and/or the resources 170. Knowledge management is not only about managing these knowledge assets but also about managing the processes that act upon the assets. These processes include: developing knowledge; preserving knowledge; using knowledge, and sharing knowledge. Therefore, knowledge management involves the identification and analysis of available and required knowledge assets and knowledge asset related processes, and the subsequent planning and control of actions to develop both the assets and the processes so as to fulfill organizational objectives.

Data mining is the automated extraction of hidden predictive information from databases. This technique allows users of the system to analyze databases to solve problems and to predict future trends and behaviors. For example, the system is given information about a variety of situations where an answer is known. The data mining software employs the data and distills the characteristics of the data that should go into a problem-solving model. Once the model is built, it can then be used in similar situations where an answer is unknown. As another example, data mining can use historical information to build a model of user behavior that can be used to predict how the user will respond to new information and what type of information the user is interested in viewing.

Case based reasoning (CBR) is based on the observation that experiential knowledge is applicable to problem solving as learning rules or behaviors. CBR stores previous experiences in memory and uses the information to solve new problems. For example, this architecture starts by placing a student in an inherently interesting situation. It then monitors the student as he works through the situation, teaching him what he needs to know at precisely the moments he wants to know it. By noticing when the student is blocked or has experienced an expectation failure, the program can know when the student is ready to learn. Timeliness is important. Stories need to be made available to the student. Students should be able to ask for advice when they want it. But they should not always have to ask for advice in order to receive it. Advice can be offered in response to actions taken by the students, or good stories can be told in response to ideas proposed by the students. The more relevant the stories, and the more compelling and visually appealing the stories, the better case-based teaching works.

From the information management techniques, the system can employ information networks to organize and represent digitally stored ideas to the user. Such a network can specify a plurality of ideas, as well as the network relationships among the ideas. Each idea may be connected to one or more other ideas. A graphical representation of the idea network is displayed to the user, including a plurality of icons corresponding to the ideas and a plurality of connecting lines corresponding to the relationships among the ideas. The users can select one or more ideas by interacting with the graphical representation to facilitate further idea generation, brainstorming, and decision making. Ideas can also be tagged by the user in order to indicate the importance of the idea to the user or to simply remind the user to revisit a particular idea. Users can also modify the network by adding or deleting new ideas and/or redrawing the connecting lines between the ideas. The relationships are then automatically redefined. It is to be appreciated that the ideas can be structured and displayed in numerous ways according to the desires of the user and/or a system administrator.

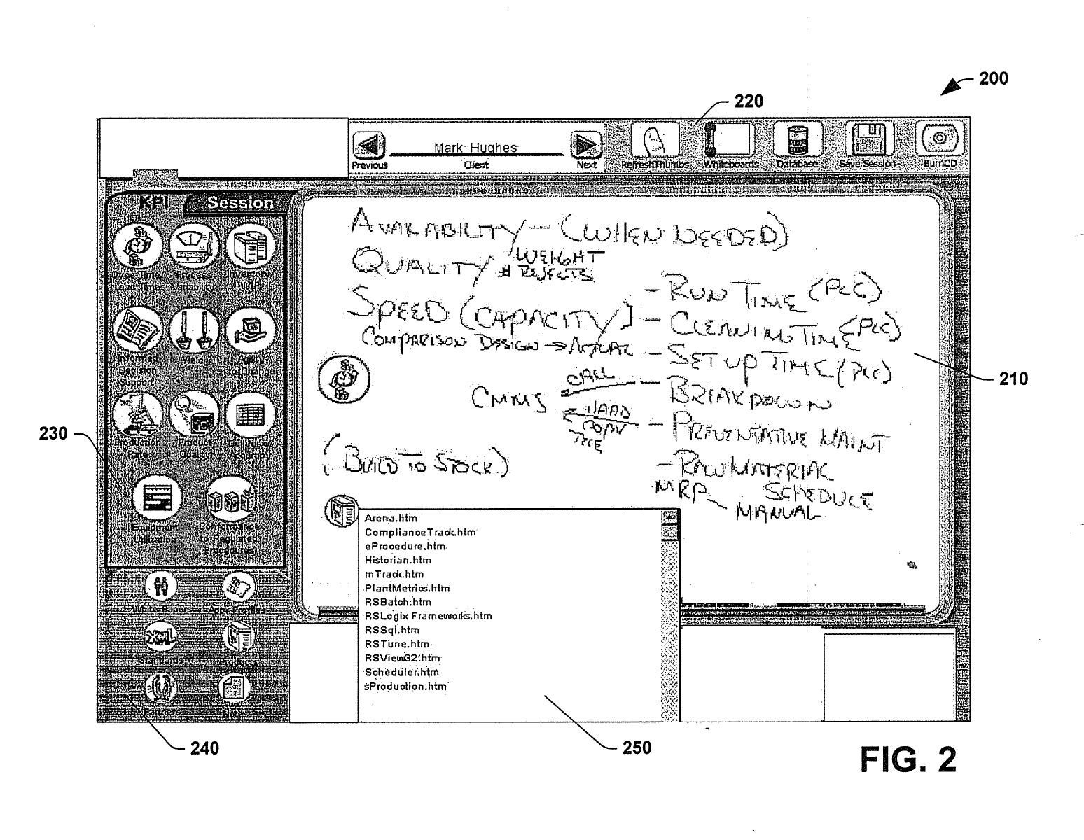

Turning to FIG. 2, a simulated screen shot of a user interface 200 in accordance with an aspect of the present invention is illustrated. The user interface 200 includes a window corresponding to base content 210. The base content window 210 displays base content (e.g., from a white board). The user interface 200 can also include a tool box 220, embedded knowledge references 230, 240 and a window 250 for displaying information related to embedded knowledge references. As information displayed in the base content window 210 changes, the embedded knowledge references 230, 240 and/or the embedded knowledge references display window can change accordingly.

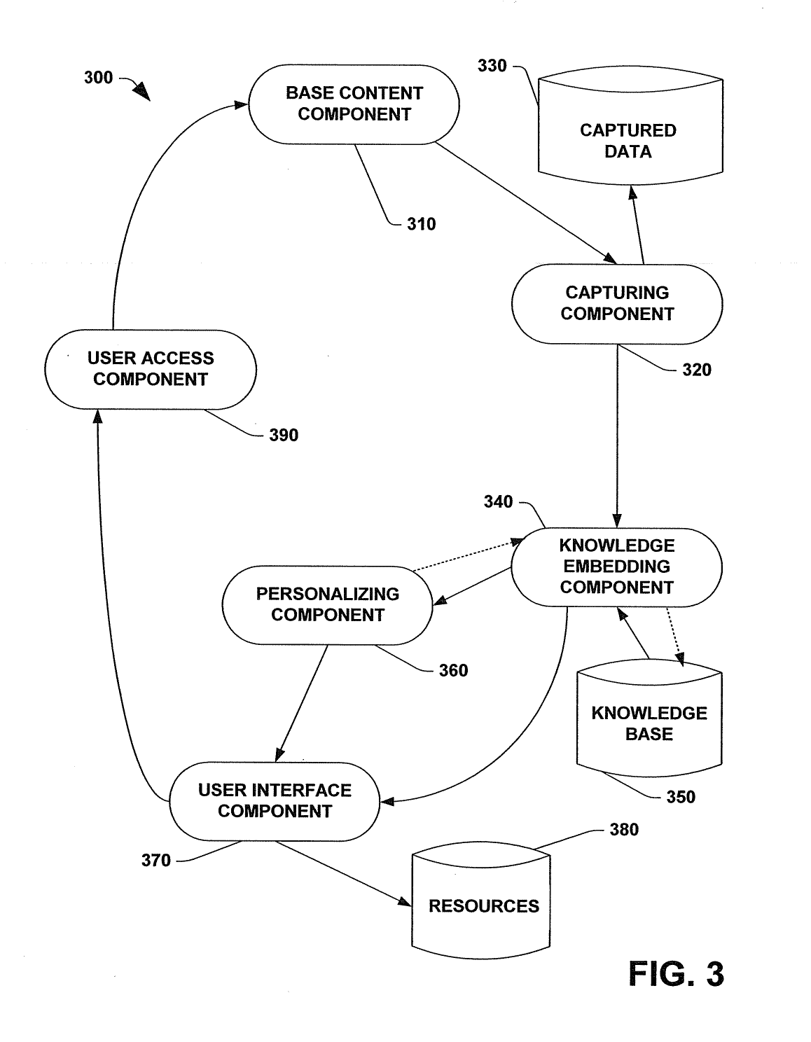

Next, referring to FIG. 3, a system for capturing content 300 is illustrated. The system 300 includes a base content component 310, a capturing component 320, captured data 330, a knowledge embedding component 340, a knowledge base 350, a user interface component 370 and resources 380. The system 300 can further optionally include a personalizing component 360 and/or a user access component 390.

The base content component 310 facilitates presentation of base content (e.g., textual document(s), graphical image(s), audio file(s), streaming audio, video file(s), streaming video, and/or computer system(s)) related to one or a plurality of task(s) (e.g., collaborative meeting, brainstorming session, classroom instruction and/or sales presentation). For example, the base content component 310 can receive information from a white-board, a web page, a graphical image, a text document, an audio file, an audio stream, a video file and/or a video stream.

The capturing component 320 can store the base content, information related to the base content and/or information related to the base content provided by the knowledge embedding component 340 in the captured data 330. At the end of a content capturing session, the capturing component 320 can permanently store information associated with the session, for example, by saving the captured data 330 to a digital medium (e.g., diskette, CD, Bernoulli cartridge and/or hard disk). The captured data 330 can then be made available for replay. In accordance with the present invention, data in the captured data 330 can be stored and/or accessed in a variety of format(s).

Accordingly, the information stored in the captured data 330 can serve, for example, as a historical record of creative efforts by participant(s) to a collaborative effort along with embedded knowledge relating to the collaborative effort.

In an instructional setting, the captured data 330 can serve as the basis for as an integrated educational experience by student(s), thus allowing student(s) to learn at their own pace and in a manner appropriate for the student. For example, those student(s) who learn better based on graphical and/or audio information as opposed to text-based information can be provided with embedded knowledge allowing them a richer education experience. Further, student(s) with a basic understanding of education material can bypass elementary concepts and concentrate on more advanced topics. Additionally, by capturing information related to changes in the base content (e.g., user identifier, time stamp and/or date stamp), an instructor can monitor level(s) of participation by individual student(s).

The knowledge embedding component 340 is adapted to provide information related to the base content and can utilize artificial intelligence (e.g., a neural network and/or an expert system) to facilitate identification of resources related to the base content. For example, in a collaborative meeting setting, a notation “PC” hand-written on a white board can be digitally recognized by the knowledge embedding component 340. Thereafter, the knowledge embedding component 340, utilizing artificial intelligence techniques, can determine that based upon the context of the meeting, the likely meaning of “PC” relates to “personal computer” and provide information to a user related to personal computers. Additionally, the knowledge embedding component 340 can employ optical character recognition (OCR) of information written on a white board. Based at least in part upon the base content, the knowledge embedding component 340 can provide access to information related to the base content (e.g., web page(s), graphical image(s), text document(s), audio file(s), audio stream(s), video file(s), video stream(s), and/or computer system(s)).

The knowledge base 350 is a store of information (e.g., web page(s), graphical image(s), text document(s), audio file(s), audio stream(s), video file(s), video stream(s), and/or computer system(s)). The knowledge base 350 can be stored locally to a user (e.g., resident on a user's system) and/or remotely (e.g., accessed via a local area network and/or the Internet). Information stored in the knowledge base 350 can be made available to a user via the user interface component 370 by the knowledge embedding component 340.

The user interface component 370 facilitates transfer of base content and information related to the base content to a user. The user interface component 370 can facilitate modification of the base content by a user. Further, the user interface component 370 can facilitate selecting and/or accessing of information related to the base content by a user. The user interface component 370 can include output device(s) (e.g., a computer monitor, a television screen, a printer, a personal digital assistant, a wireless telephone display and speaker(s)) and/or input device(s) (keyboard, a pointing device, such as a mouse, a microphone, an IR remote control, a joystick, a game pad and/or a personal digital assistant (PDA), kinematic sensor(s) (e.g., glove) and/or eye sensor(s)).

For example, the embedding component 340 can provide hyperlinked resources 380 related to the base content available via the Internet. By clicking the hyperlink, a user can be presented with information related to the base content. In a collaborative meeting in an industrial setting, a meeting participant can be provided with a hyperlink to his employer's inventory management system in order for the participant to more fully participate in the collaborative meeting.

The resources 380 can include information (e.g., web page, a graphical image, a text document, an audio file, an audio stream, a video file and/or a video stream) related to base content and provide the opportunity for a user to gain further information related to the base content. The resources 380 can be available locally (e.g., within a user system itself) and/or remotely (e.g., via a local area network and/or the Internet).

The personalizing component 360 can filter base content and/or information provided by the knowledge embedding component 340 (e.g., based upon a type of user, type of information, historical information and/or personal information). For example, the personalization component 360 can determine that based upon a type of user (e.g., student) certain information (e.g., hyperlink to answers to homework assignment) should not be made available to a user at a given time. Optionally, the personalizing component 360 can be adapted to provide feedback to the knowledge embedding component 340, thus facilitating the knowledge embedding component 340 and/or the knowledge base 350 to be adaptively modified.

The user access component 390 is adapted to determine an amount of the base content a user is permitted to modify. Users can be assigned rights to modify base content. For example, user(s) can be assigned the right to “read but not modify” or “read and modify” base content.

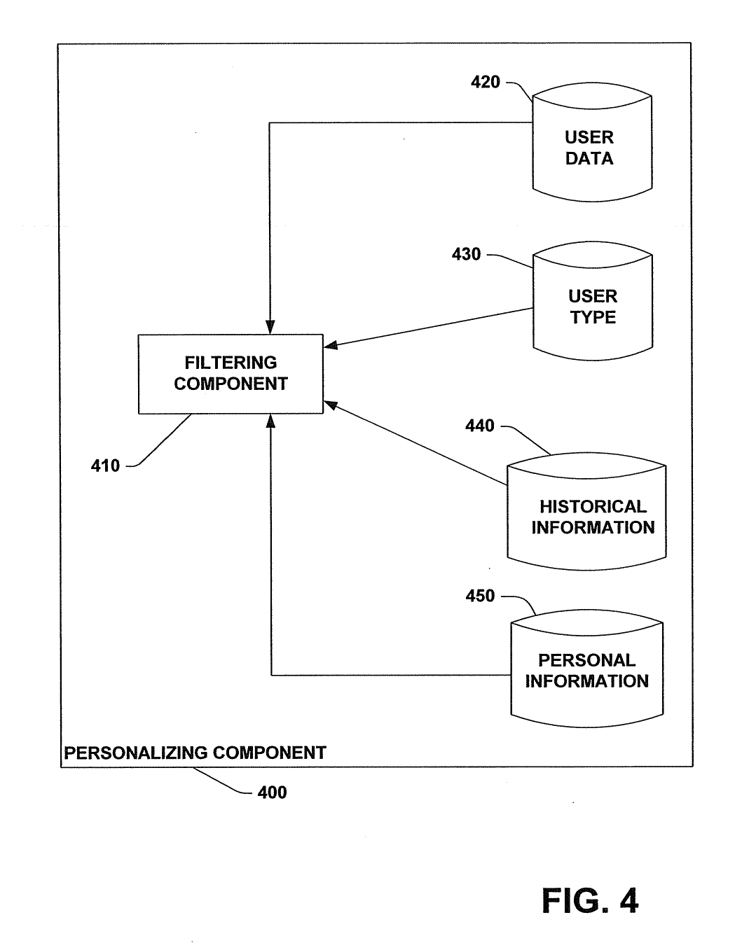

Turning to FIG. 4, a personalizing component 400 in accordance with an aspect of the present invention is illustrated. The personalizing component 400 can include a filtering component 410, user data 420, user type 430, historical information 440 and/or personal information 450.

The filtering component 410 can determine base content and/or information related to base content available for a user to view, modify and/or access. The filtering component 410 can utilize information stored in the user data 420, user type 430, historical information 440 and/or personal information 450. Additionally, the filtering component 410 can utilize one or more stochastic technique(s) and/or artificial intelligence techniques including, but not limited to, Bayesian models, probability tree networks, fuzzy logic, expert systems and/or neural networks, to determine base content and/or information related to base content to present to a user. Further, as successive base content and/or information related to base content is accessed, the personalizing component can adaptively update the user data 420, user type 430, historical information 440 and/or personal information 450.

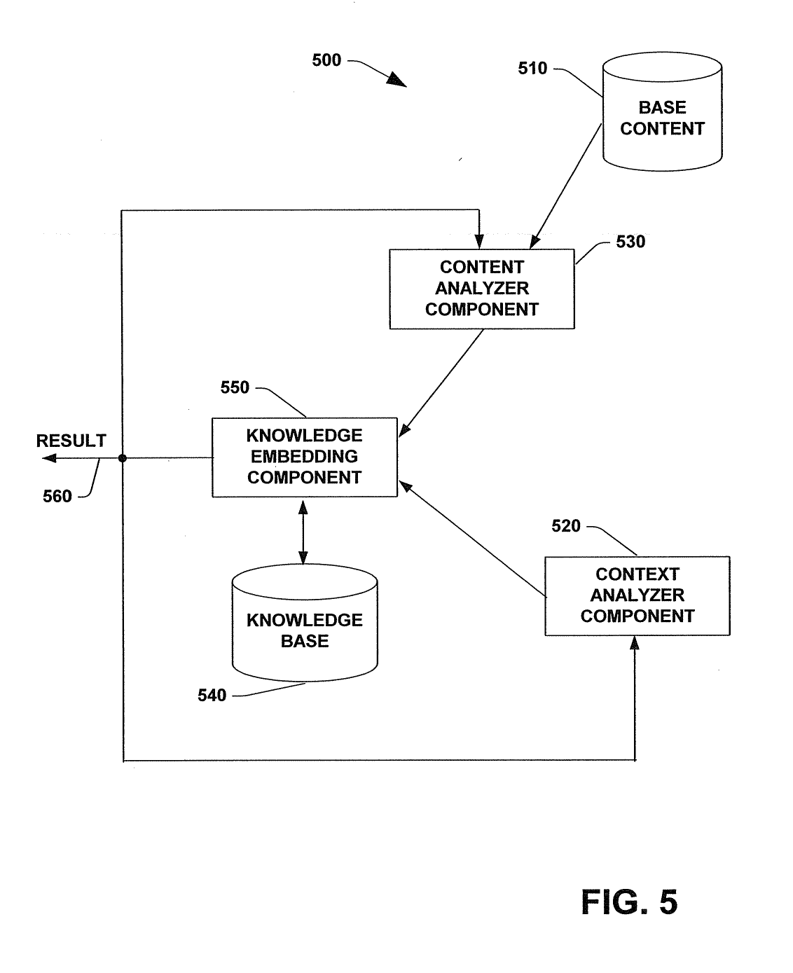

Next, referring to FIG. 5, a system for providing embedded knowledge 500 is illustrated. The system 500 includes base content 510, a context analyzer component 520, a content analyzer component 530, a knowledge base 540, a knowledge embedding engine 550. The knowledge embedding engine 550 produces a result 560.

The base content 510 includes base content (e.g., textual document(s), graphical image(s), audio file(s), streaming audio, video file(s), streaming video, and/or computer system(s)) related to one or a plurality of task(s) (e.g., collaborative meeting, brainstorming session, classroom instruction and/or sales presentation). For example, the base content 510 can be an input from a white-board, a web page, a graphical image, a text document, an audio file, an audio stream, a video file and/or a video stream.

The context analyzer component 520 is adapted to analyze context of base content 510. The context analyzer component 520 can further receive the result 560 of the knowledge embedding engine 550. The context analyzer component 520 can, for example, utilize artificial intelligence technique(s), to determine the context of base content 510. Based at least in part upon the base content 510 and/or the result 560 of the knowledge embedding engine 550, the context analyzer component 520 can provide a result to the knowledge embedding engine 550.

The content analyzer component 530 is adapted to analyze the content of base content 510. The content analyzer component 530 can further receive the result 560 of the knowledge embedding engine 550. The content analyzer component 530 can, for example, utilize optical character recognition to receive hand-written text and/or graphic(s) on a white board. The content analyzer component 530 can utilize artificial intelligence technique(s) to determine the content of the base content 510 (e.g., recognizing possible meaning(s) for abbreviation(s)). For example, the content analyzer component 530 can analyze a hand-written notation and provide a result to the knowledge embedding engine.

The knowledge base 540 is a store of information (e.g., web page(s), graphical image(s), text document(s), audio file(s), audio stream(s), video file(s), video stream(s), and/or computer system(s)). The knowledge base 540 can be stored locally to a user (e.g., resident on a user's system) and/or remotely (e.g., accessed via a local area network and/or the Internet).

The knowledge embedding engine 550 is adapted to search the knowledge base 540 and provide a result having at least one embedded knowledge reference based, at least in part, upon the result of the content analyzer component 530 and the result of the context analyzer component 520. Further, the knowledge embedding engine 550 can utilize predictive technique(s) in determining the result 560 of the knowledge embedding engine 550. For example, based, at least in part, upon analysis of the content analyzer component 530, the context analyzer component 520 and the knowledge base 540, the knowledge embedding engine 550 can predict the likelihood that particular resource(s) are suitable (e.g., for a user).

The result 560 of the knowledge embedding engine 550 can be utilized by a user (not shown). Additionally, the result 560 of the knowledge embedding engine 550 can be utilized by the content analyzer component 530 and/or the context analyzer component 520, for example, to adaptively respond to respond to change(s) in the system 500.

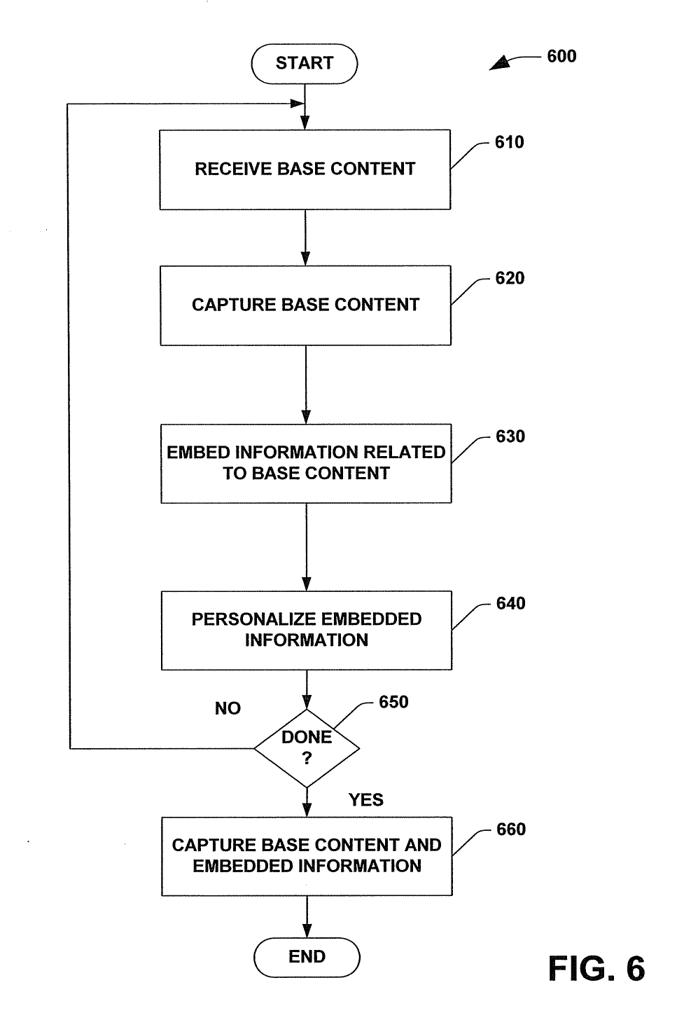

In view of the exemplary systems shown and described above, a methodology, which may be implemented in accordance with the present invention, will be better appreciated with reference to the flow chart of FIG. 6. While, for purposes of simplicity of explanation, the methodology is shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement a methodology in accordance with the present invention. In addition, it will be appreciated that the exemplary method 600 and other methods according to the invention may be implemented in association with the content capturing system illustrated and described herein, as well as in association with other systems and apparatus not illustrated or described.

The invention may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Turning to FIG. 6, a methodology 600 for capturing content in accordance with an aspect of the present invention is illustrated. At 610, base content is received. At 620, the base content is captured (e.g., stored to disk or in RAM). At 630, information related to the base content is embedded (e.g., hyperlinks to resource(s) available via the Internet). At 640, the embedded information is personalized (e.g., based upon a user, type of user, historical information and/or personal information). At 650, a determination is made whether the user is done (e.g., session completed). If the determination at 650 is NO, processing continues at 510. If the determination at 650 is YES, at 660 base content and embedded information is captured (e.g., transferred to CD).

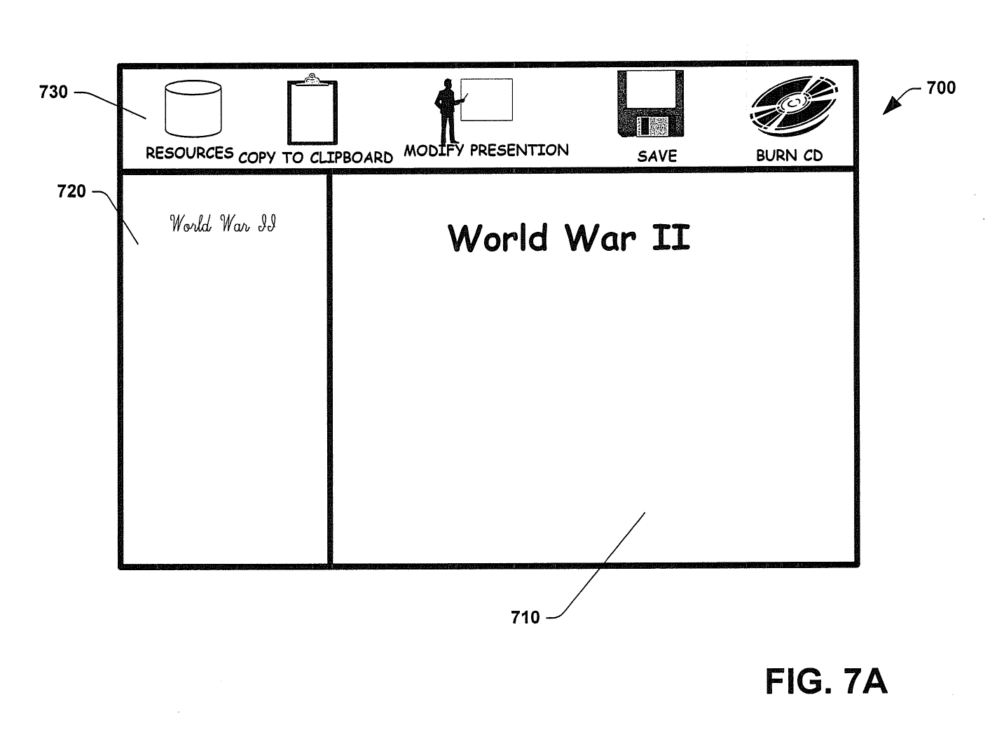

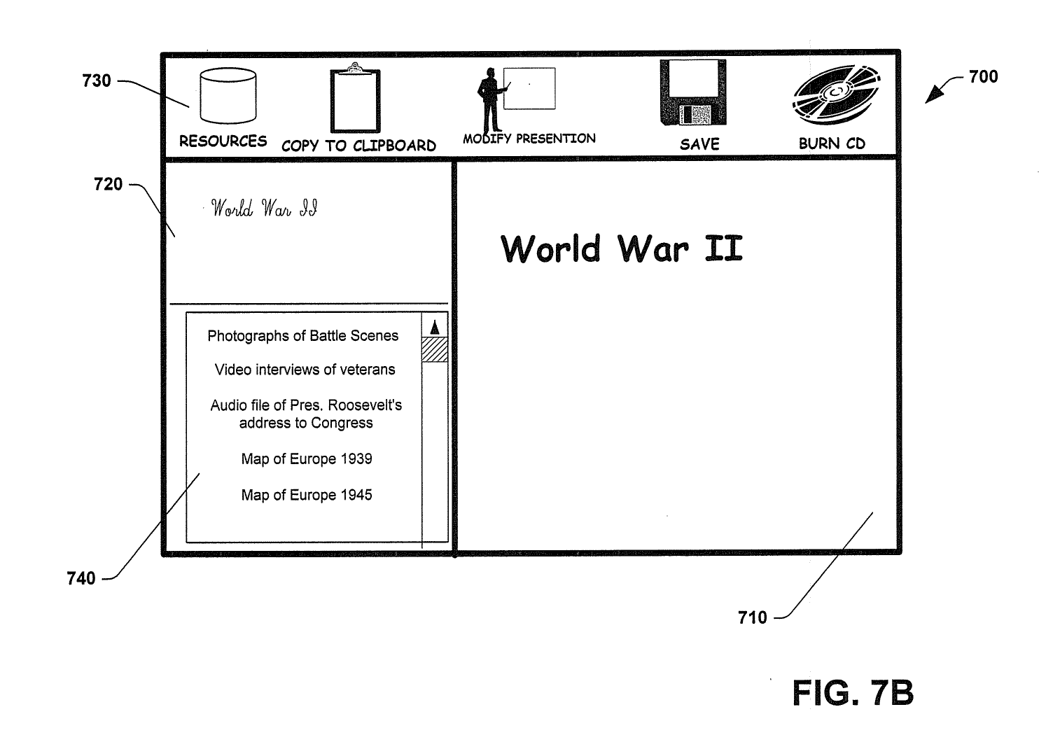

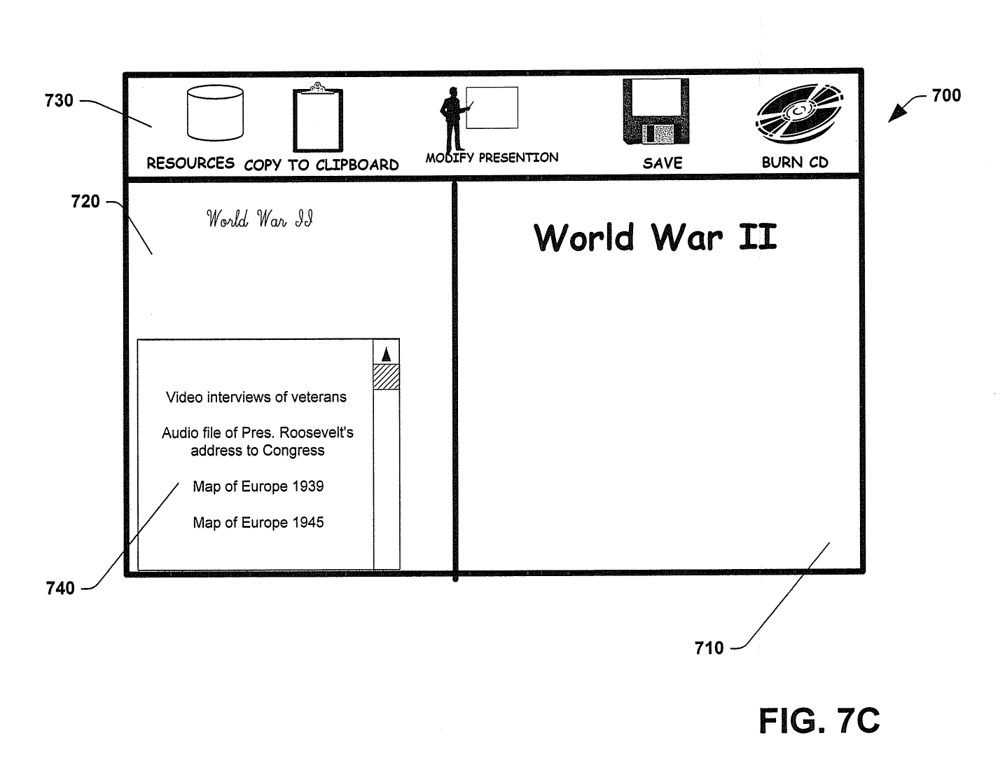

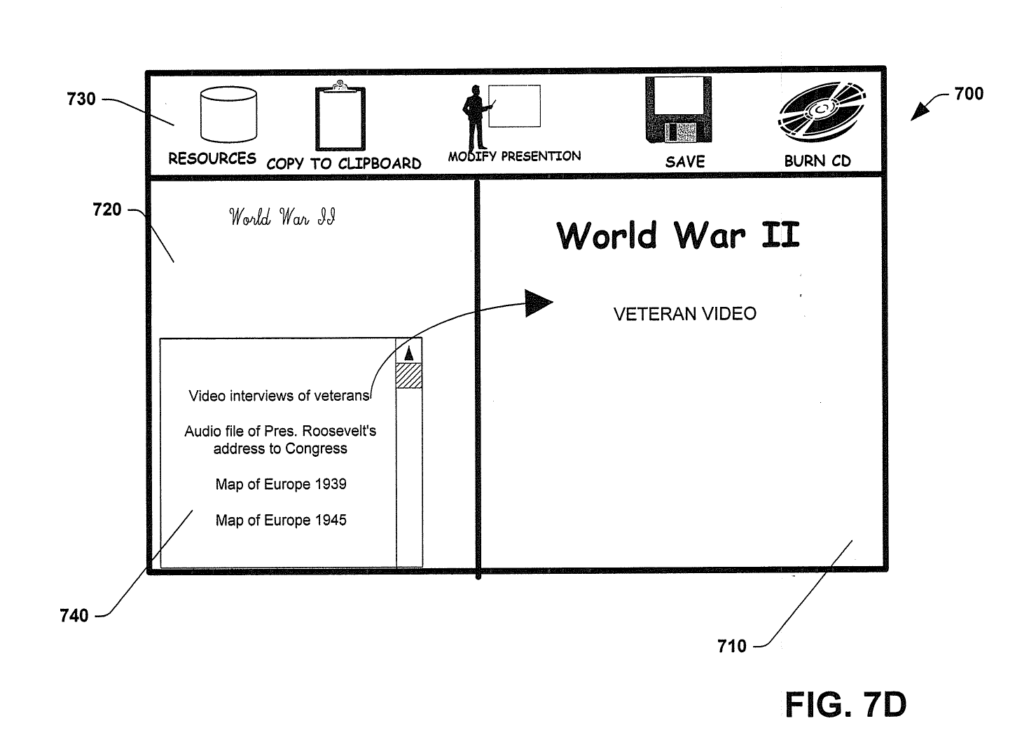

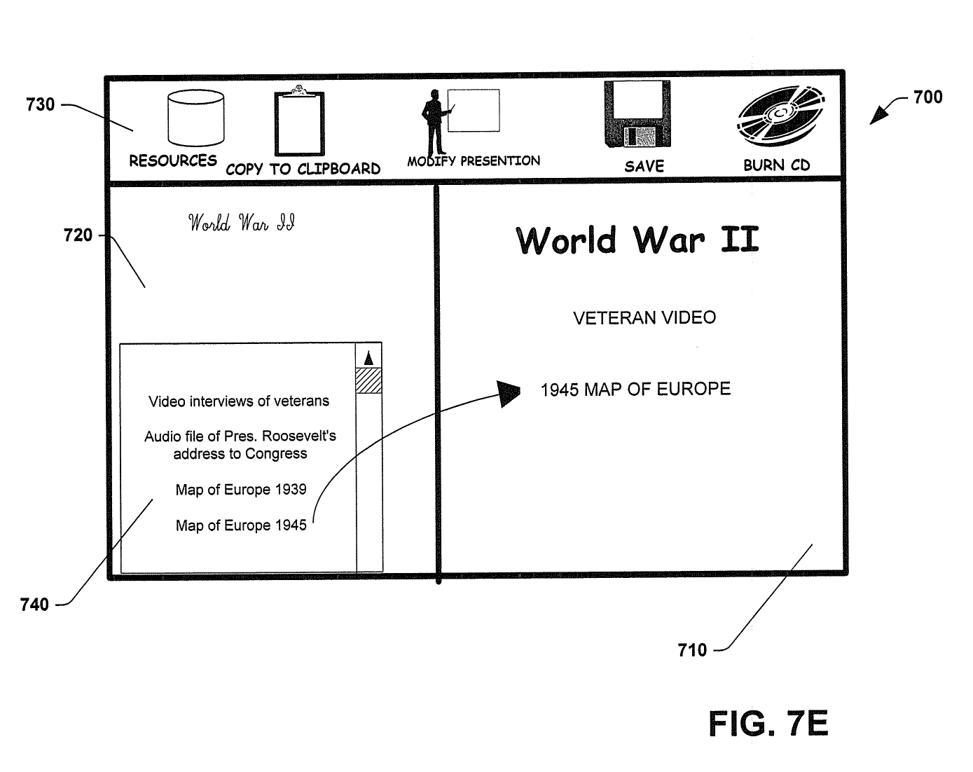

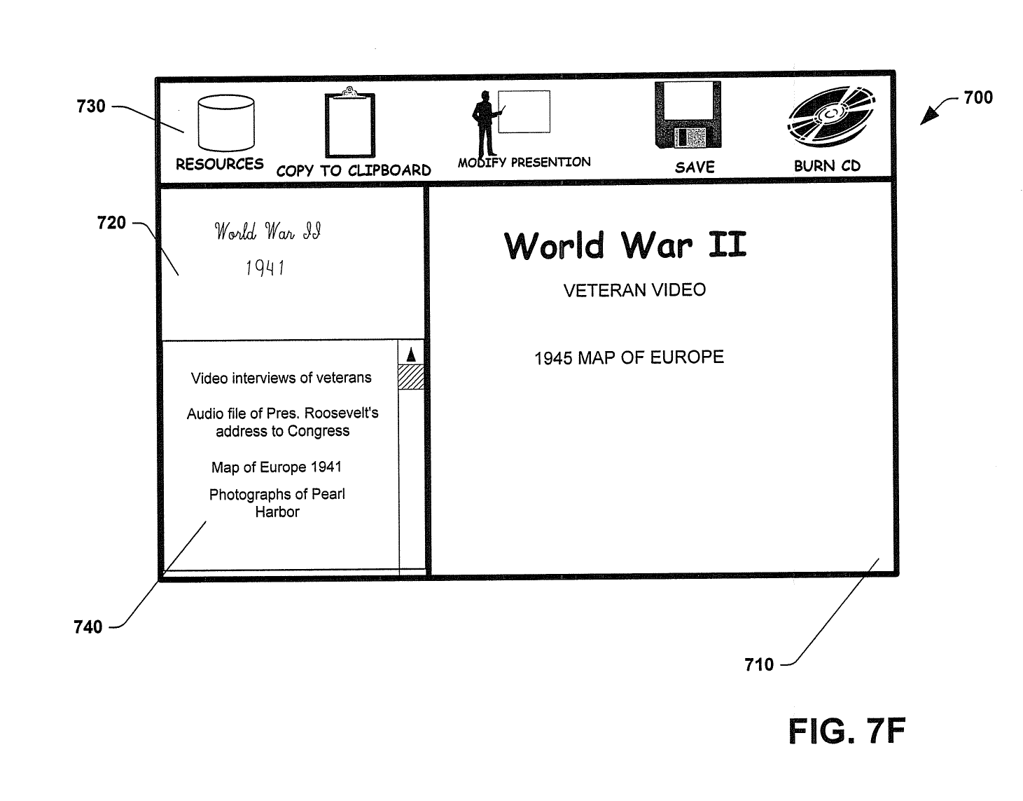

Turning to FIGS. 7A through 7F, simulated screen shots of a user interface 700 in accordance with an aspect of the present invention is illustrated. The user interface 700 includes a display window 710, a base content input window 720, a tool box 730 and a window for displaying information related embedded knowledge references 740.

Referring to FIG. 7A, base content input, “World War II” is received (e.g., from a white board device) and displayed in the base content input window 720. For example, the purpose for utilizing the content capturing system can be to prepare and organize an educational presentation for students to view at their own pace. The base content is analyzed (e.g., by a content analyzing component) and displayed in the display window 710. Next, referring to FIG. 7B, embedded knowledge references—“Photographs of Battle Scenes”, “Video interviews of veterans”, “Audio file of Pres. Roosevelt's address to Congress”, “Map of Europe 1939” and “Map of Europe 1945”—are shown in the embedded knowledge reference display window 740. Referring to FIG. 7C, in this example, the user (e.g., teacher) has removed the embedded knowledge reference to “Photographs of Battle Scenes” deciding that these resources are inappropriate for her students. Next, Referring to FIGS. 7D and 7E, the user has selected the embedded knowledge references “Video interviews of veterans” and “1945 Map of Europe” to be included in the presentation. Finally, referring to FIG. 7F, the user has added base content “1941” and the embedded knowledge reference display window 740 and changed accordingly displaying references to “video interviews of veterans”, “Audio file of Pres. Roosevelt's address to Congress”, “Map of Europe 1941” and “Photographs of Pearl Harbor”. Once the user has completed the presentation the user can utilize the tool box 730 to save the presentation for later use by student(s).

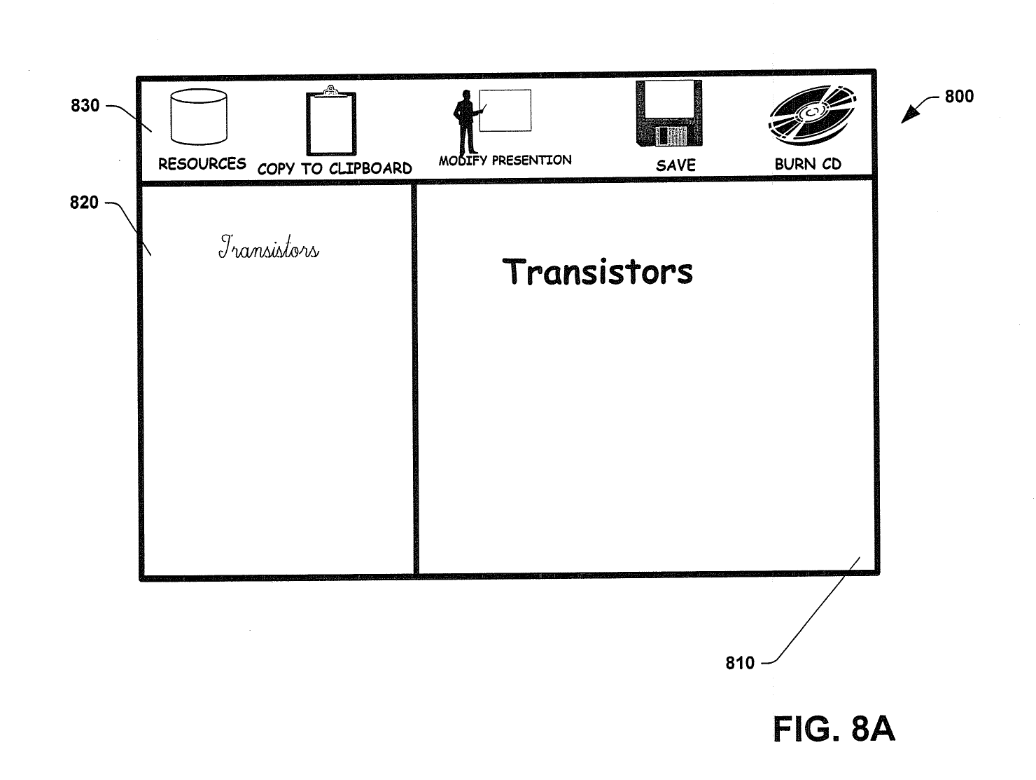

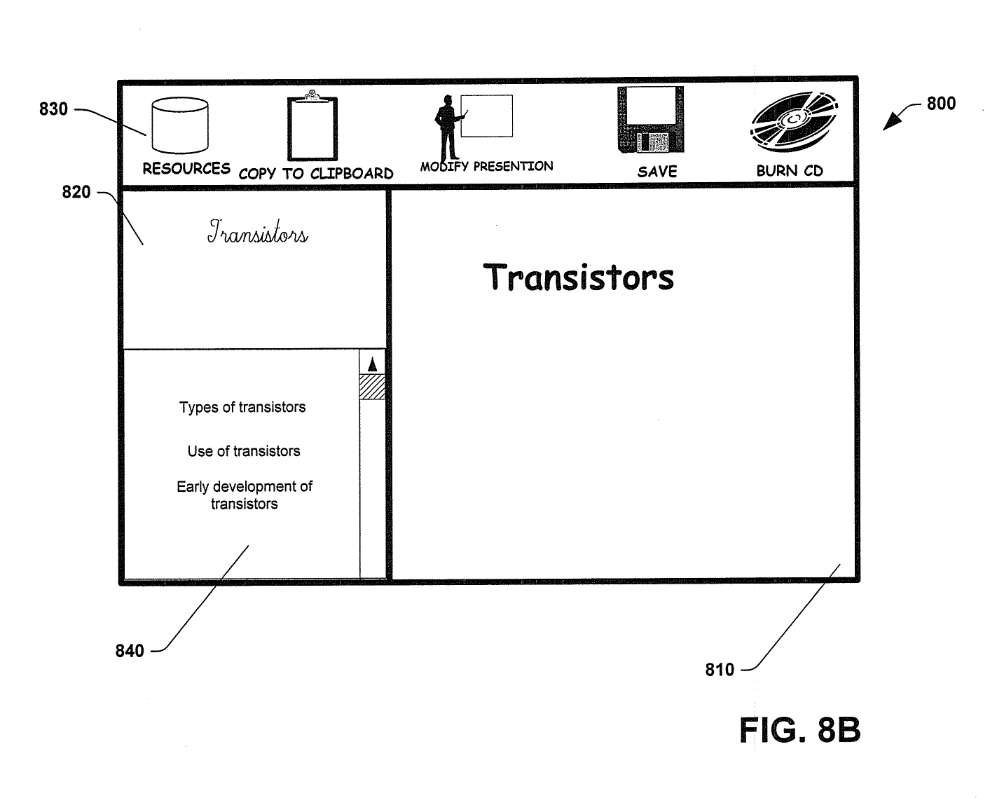

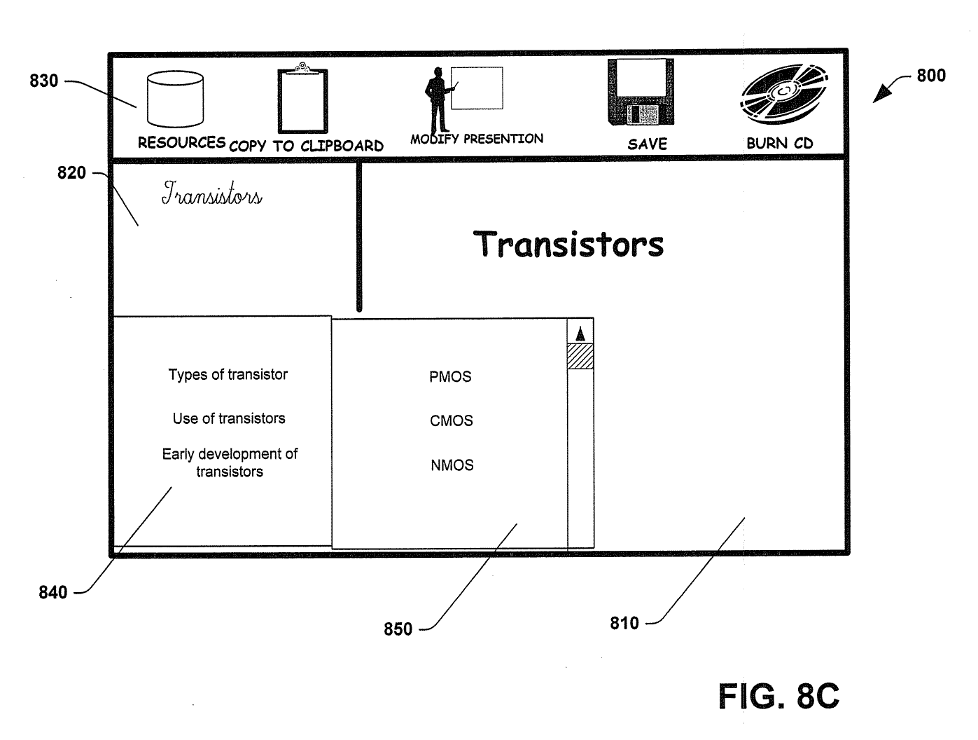

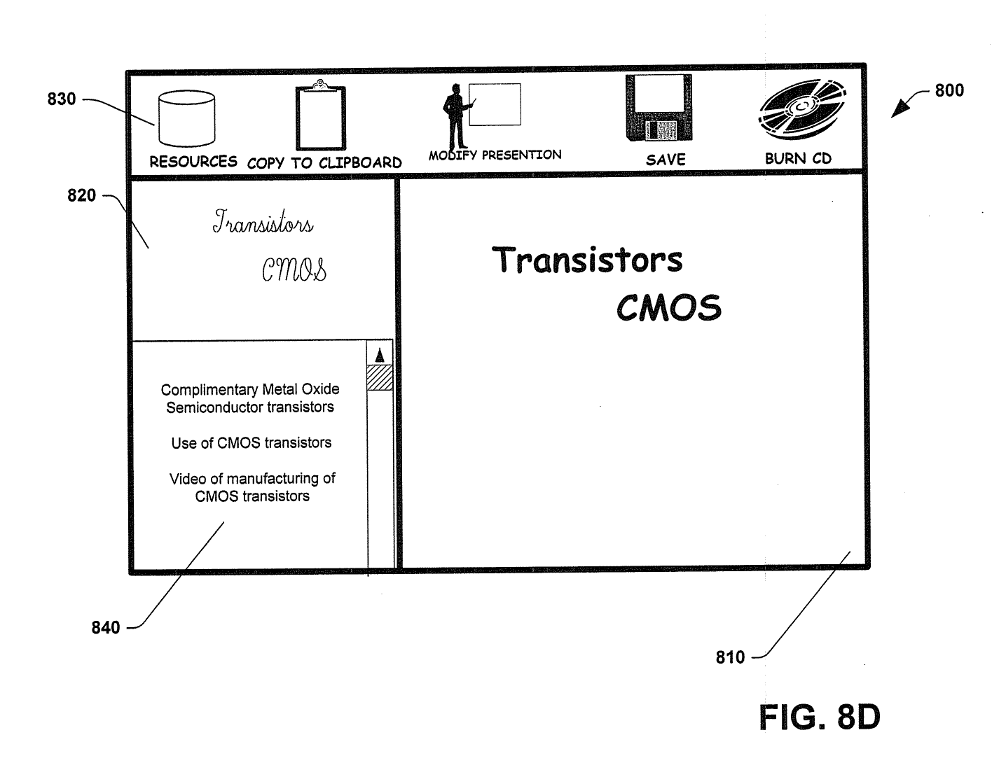

Next, referring to FIGS. 8A through 8D, simulated screen shots of a user interface 800 in accordance with an aspect of the present invention are illustrated. The user interface 800 includes a display window 810, a base content input window 820, a tool box 830 and a window for displaying information related embedded knowledge references 840.

Referring to FIG. 8A, base content input, “Transistors” is received (e.g., from a white board device) and displayed in the base content input window 820. For example, the purpose for utilizing the content capturing system can be to facilitate an interactive educational experience. The base content is analyzed (e.g., by a content analyzing component) and displayed in the displayed window 810. Next, referring to FIG. 8B, embedded knowledge reference—“Types of transistors”, “Use of transistors”, “Early development of transistors”—are shown in the embedded knowledge reference display window 840. Turning to FIG. 8C, a user of the system (e.g., a student) has selected the embedded knowledge reference “Types of transistors” which has lead to a second embedded knowledge reference display window 850 displaying further embedded knowledge references—“PMOS” “CMOS” and “NMOS”. As illustrated in FIG. 8D, the user of the system (e.g., student) has elected to participate in the interactive education experience by adding “CMOS” to the base content as illustrated in the base content input window 820. Prior to inclusion of this additional base content, the content capturing system can wait for approval (e.g., by an instructor).

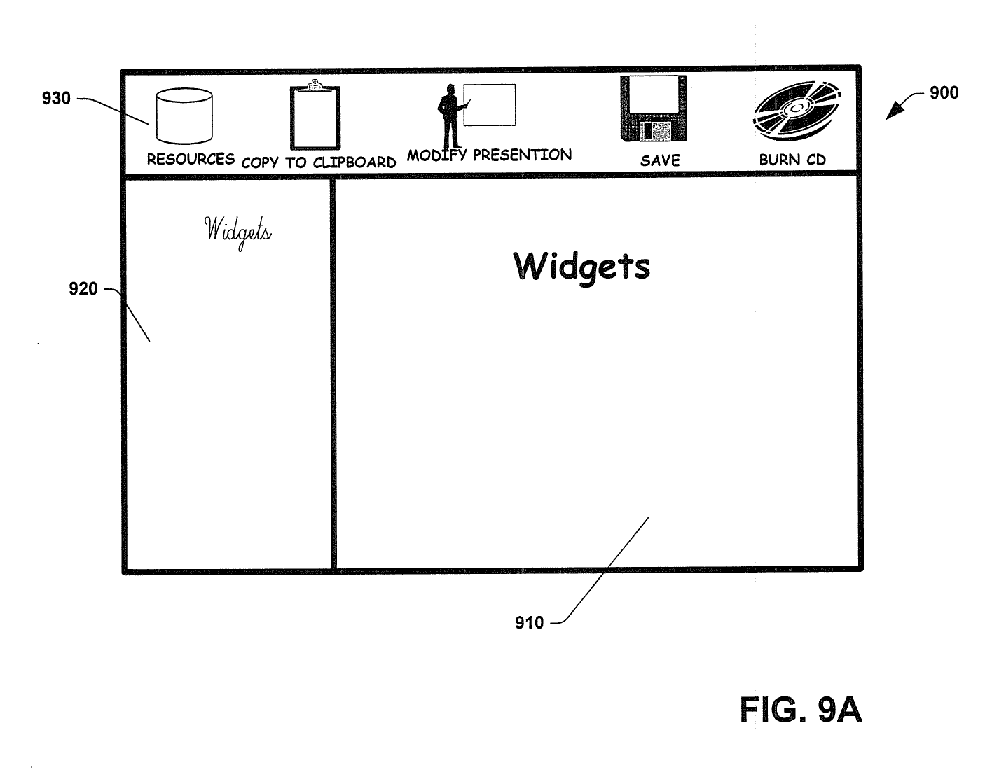

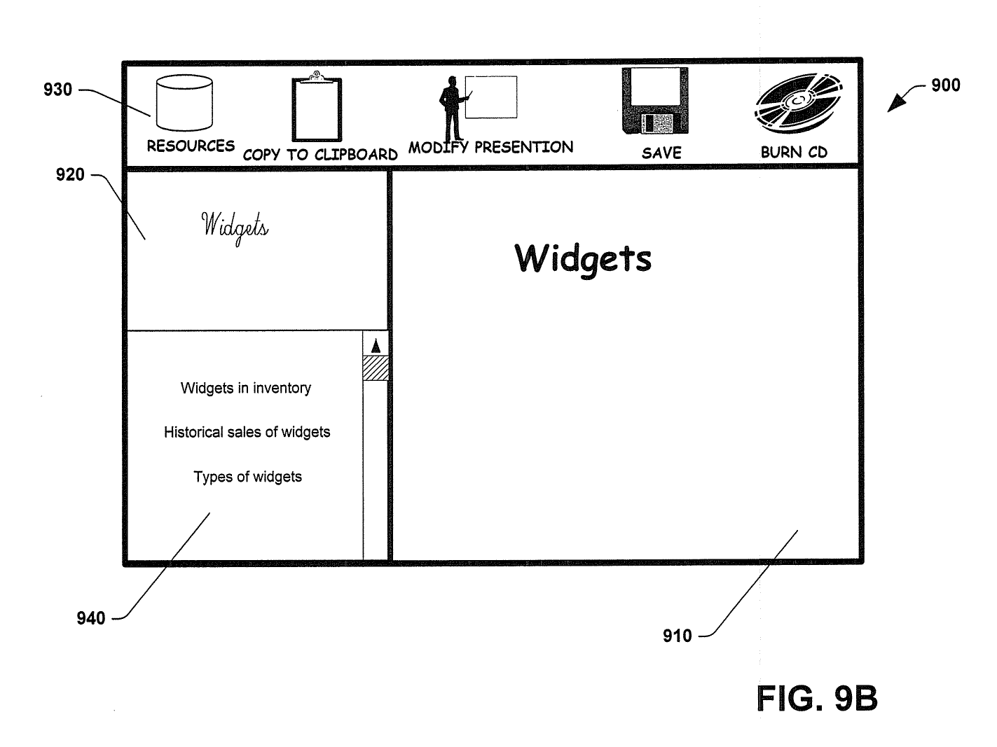

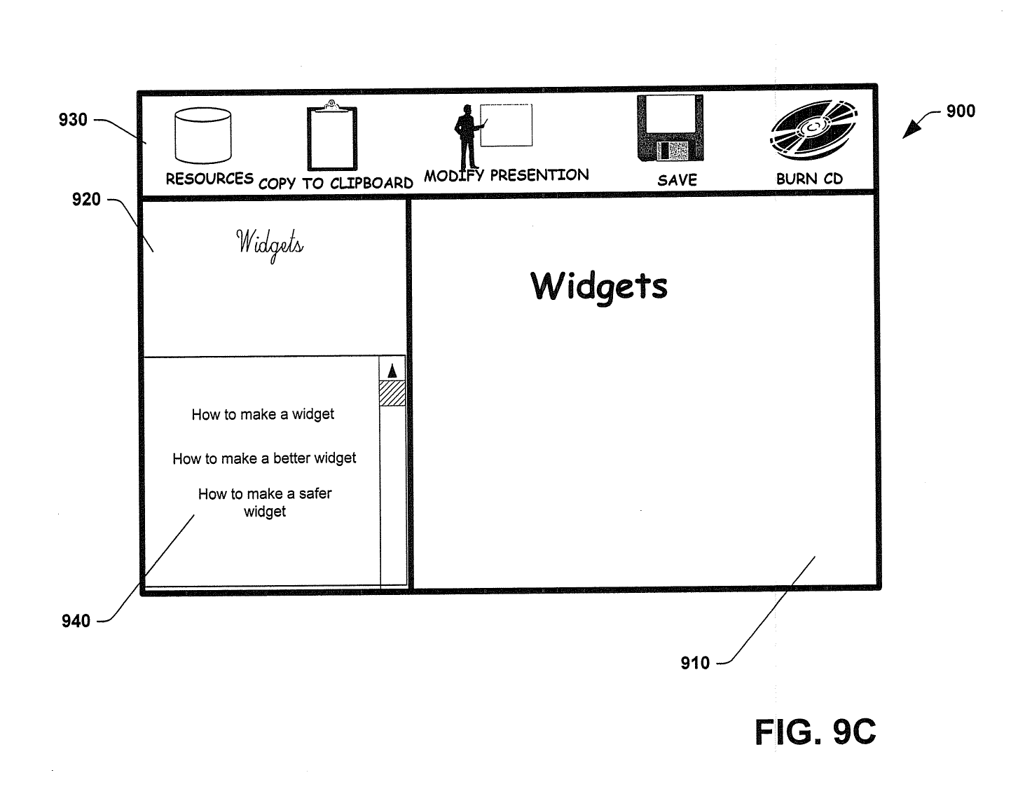

Referring to FIGS. 9A through 9C, simulated screen shots of a user interface 900 in accordance with an aspect of the present invention are illustrated. The user interface 900 includes a display window 910, a base content input window 920, a tool box 930 and a window for displaying information related embedded knowledge references 940.

Referring to FIG. 9A, base content input, “Widgets” is received (e.g., from a white board device) and displayed in the base content input window 920. For example, the purpose for utilizing the content capturing system can be to facilitate a collaborative business meeting. The base content is analyzed (e.g., by a content analyzing component) and displayed in the display window 910. Next, referring to FIGS. 9B and 9C, embedded knowledge reference can be shown in the embedded knowledge reference display window 940. Significantly, the information displayed in the embedded knowledge reference display window 940 can depend upon a type of user. Referring to FIG. 9B, information displayed in the embedded knowledge reference display window 940—“Widgets in inventory”, “Historical sales of widgets” and “Types of widgets”—are personalized (e.g., filtered by a personalizing component) for a person responsible for marketing. In contrast, referring to FIG. 9C, information displayed in the embedded knowledge reference display window 940—“How to make a widget”, “How to make a better widget” and “How to make a safer widget”—are personalized (e.g., filtered by a personalizing component) for an engineer.

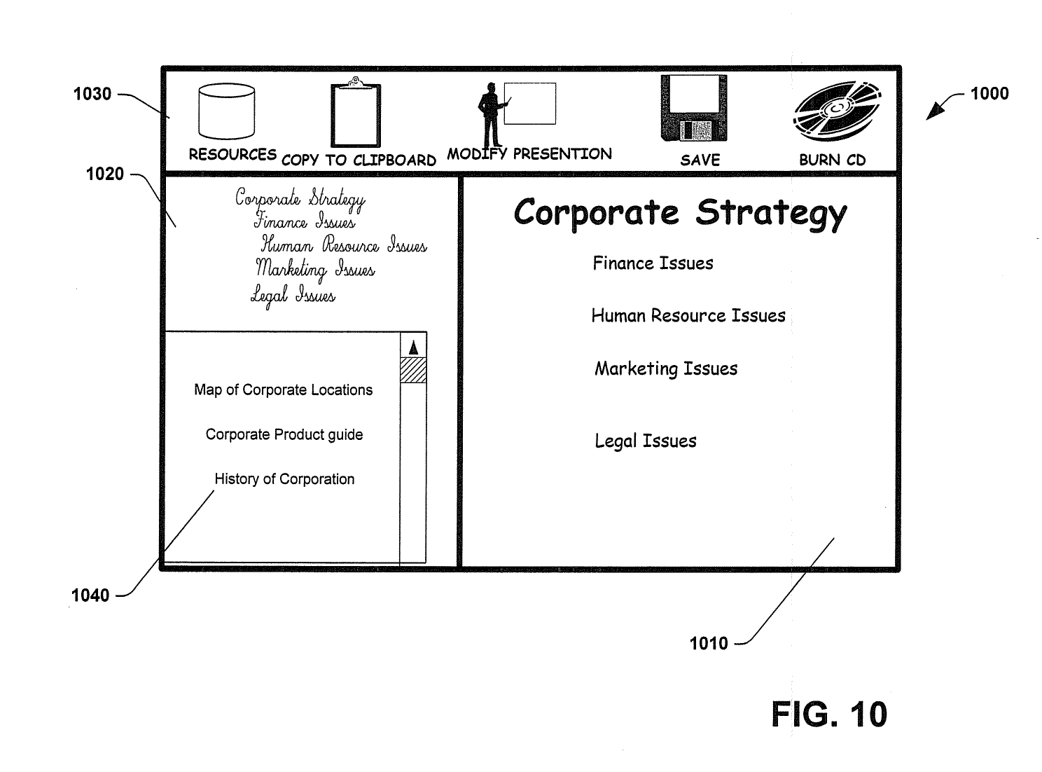

Turning to FIG. 10, a simulated screen shot of a user interface 1000 in accordance with an aspect of the present invention is illustrated. The user interface 1000 includes a display window 1010, a base content input window 1020, a tool box 1030 and a window for displaying information related embedded knowledge references 1040. While the collaborative activity (e.g., business meeting) illustrated in FIG. 10 contains base content and embedded knowledge references to various disciplines (e.g., finance, human resources, marketing and legal), once the collaborative activity (e.g., business meeting) has ended, as preprogrammed into the content capturing system and/or at a user's selection, base content and/or embedded knowledge references relevant to the particular user can be captured for that user. For example, a finance participant can leave the collaborative activity (e.g., business meeting) with captured content (e.g., a portable computer readable medium, for example, a diskette and/or CD) having information (e.g., base content and/or embedded knowledge reference(s)) relevant to finance, while a marketing participant can leave the collaborative activity (e.g., business meeting) with captured content having information relevant to marketing.

At any time during the sessions described above, the user can record the briefing, tutoring, problem-solving, and/or exploratory session and save it in a historical register, which would allow the user to replay the session and modify it as desired. During the original and replay sessions, the user has the options, such as pause, slow, fast forward and resume to tailor the session to his desired speed. The historical register can store the sessions by the date and time of the original session, the topic of the session, the type of session, etc., depending upon the user's specifications.

As computer network technologies have advanced, computer systems have been changed from centralized systems of which host computers perform all processes thereof to distributed system of which a plurality of computers that are connected through a network perform respective processes. Thus, the problem solving systems, as described above, can communicate with other systems to facilitate the decomposition of problems or the pursuing and/or solving of sub-problems (in parallel or sequentially) by the other systems. For example, a distributed problem solving method can be used in which each system is assigned individual problem solving criterion and infers a process thereof.

Problem decomposition includes, first finding the solution to subproblems and then reusing these solutions to find solutions to the whole problem. For example, the problem of designing a vehicle can be decomposed into designing the engine and designing the body. It is acknowledged that most real-world problems (vehicles included) do not decompose neatly into separable subproblems. For example, the optimal properties of a drive system have dependencies with the passenger capacity. Nonetheless, it is often possible to simplify a problem greatly by identifying subproblems that exhibit some degree of independence.

Multi-Objective Optimization (MOO) is another type of problem solving, in which there are several features of a system that are optimized simultaneously and alternatives are examined that optimize each of the features independently, and/or offer a compromise of multiple objectives simultaneously. For example, we wish to minimize both the materials cost and construction time for our vehicle. It is acknowledged that sometimes multiple objectives can be satisfied simultaneously. For example, perhaps there is a simple design that is both cheap and fast to manufacture. This is the basis of Pareto dominance; a solution that is preferred with respect to all objectives. Nonetheless, it is often useful to acknowledge that objectives are constrained and to accept a set of solutions that optimize different objectives, rather than a single compromise.

Aggregation can be applied to a subproblem, findings, or solution in order to reduce its size. Aggregation summarizes a number of individual tasks and replaces them by one composite task. Dynamic concept generation can also be used, which exploits background knowledge to interactively generate explanation at a desired level of abstraction. This procedure responds to a user's query, isolates temporal data relevant to answer this query, then modifies the data by applying summarization and generalization operators in a principled manner, and eventually presents the user with a concise description of the required information. Since any term in a temporal proposition can be described according to a number of concept hierarchies, the user is prompted to interactively specify the “abstraction requirements” (e.g., the level of granularity, the abstraction axis).

The system, as described above, compliments Intelligent Tutoring Systems (ITS), which use simulations and other highly interactive learning environments that require users to apply their knowledge and skills. These active, situated learning environments help users retain and apply knowledge and skills more effectively in operational settings. In order to provide hints, guidance, and instructional feedback to learners, ITS systems typically rely on three types of knowledge, organized into separate software modules. An “expert model” represents subject matter expertise and provides the ITS with knowledge of what it's teaching. A “student model” represents what the user does and doesn't know, and what he or she does and doesn't have. This knowledge lets the ITS know who it's teaching. An “instructor model” enables the ITS to know how to teach, by encoding instructional strategies used via the tutoring system user interface.

The expert model is a computer representation of a domain expert's subject matter knowledge and problem-solving ability. This knowledge enables the ITS to compare the learner's actions and selections with those of an expert in order to evaluate what the user does and doesn't know. A variety of artificial intelligence (AI) techniques are used to capture how a problem can be solved. For example, some ITS systems capture subject matter expertise in rules. That enables the tutoring system to generate problems on the fly, combine and apply rules to solve the problems, assess each learner's understanding by comparing the software's reasoning with theirs, and demonstrate the software's solutions to the participant's. Though this approach yields a powerful tutoring system, developing an expert system that provides comprehensive coverage of the subject material is difficult and expensive. A common alternative to embedding expert rules is to supply much of the knowledge needed to support training scenarios in a scenario definition. For example, procedural task tutoring systems enable a course developer to create templates that specify an allowable sequence of correct actions. This method avoids encoding the ability to solve all possible problems in an expert system. Instead, it requires only the ability to specify how the learner should respond in a scenario. Which technique is appropriate depends on the nature of the domain and the complexity of the underlying knowledge.

The student model evaluates each learner's performance to determine his or her knowledge, perceptual abilities, and reasoning skills. For example, imagine that three learners are presented with addition problems. Although all three participants may answer incorrectly, different underlying misconceptions cause each person's errors. Student A fails to carry, Student B always carries (sometimes unnecessarily), and Student C has trouble with single-digit addition. In this example, the student supplies an answer to the problem, and the tutoring system infers the student's misconceptions from this answer. By maintaining and referring to a detailed model of each user's strengths and weaknesses, the ITS can provide highly specific, relevant instruction. In more complex domains, the tutoring system can monitor a learner's sequence of actions to infer his or her understanding. For example, a system can apply pattern-matching rules to detect sequences of actions that indicate whether the student does or doesn't understand. A report card can be used to provide the times at which the learner performed incorrect actions and a list of principles that he or she passed or failed in the simulation.

The instructor model encodes instructional methods that are appropriate for the target domain and the learner. Based on its knowledge of a person's skill strengths and weaknesses, participant expertise levels, and student learning styles, the instructor model selects the most appropriate instructional intervention. For example, if a student has been assessed a beginner in a particular procedure, the instructor module might show some step-by-step demonstrations of the procedure before asking the user to perform the procedure on his or her own. It may also provide feedback, explanations, and coaching as the participant performs the simulated procedure. As a learner gains expertise, the instructor model may “decide” to present increasingly complex scenarios. It may also decide to take a back seat and let the person explore the simulation freely, intervening with explanations and coaching only upon request. Additionally, the instructor model may also choose topics, simulations, and examples that address the user's competence gaps.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes”, “including”, “has”, “having”, and variants thereof are used in either the detailed description or the claims, these terms are intended to be inclusive in a manner similar to the term “comprising.”

What is claimed is:

1. A system, comprising:
a capture component configured to obtain base content from a device, wherein the capture component is further configured to store a representation of the base content on a first storage medium; and
a knowledge retrieval component configured to:
determine semantics of the base content,
search a set of resources based on the semantics, and
obtain, based on the semantics of the base content, additional information related to the base content from the set of resources,
wherein the capture component is further configured to receive input that identifies a subset of the additional information, to automatically incorporate the subset of the additional information into the representation of the base content, and to store the representation of the base content and the subset of the additional information on a second storage medium.

2. The system of claim 1, wherein the device is a computing device and the base content is at least one a web page, a graphical image, a text document, an audio portion, or a video portion.

3. The system of claim 1, wherein the capture component is further configured to store at least one of a user identifier, a time stamp, or a date stamp in association with the base content.

4. The system of claim 1, wherein the device is a white board device, and the base content comprises content written on the white board device.

5. The system of claim 4, wherein the knowledge retrieval component is further configured to employ optical character recognition on the content written on the white board device to generate a textual representation of the base content.

6. The system of claim 1, further comprising a personalization component configured to filter at least one of the base content or the subset of the additional information based on at least one of a user role, historical information, personal information, or a context.

7. A method, comprising:
receiving base content from a device;
storing the base content on a first computer-readable storage medium;
analyzing the base content to determine semantics of the base content;
searching a set of resources based on the semantics of the base content;
identifying, based on the semantics, additional information, stored in the set of resources, related to the base content;
receiving a selection of a portion of the additional information;
automatically modifying the base content to incorporate the portion of the additional information; and
storing the base content and the portion of the additional information on a second computer-readable storage medium.

8. The method of claim 7, wherein the modifying the base content further comprises storing the portion of the additional information on the second computer-readable storage medium in association with the base content.

9. The method of claim 7, further comprising filtering the base content and the portion of the additional information associated based on a user role to generate filtered content.

10. The method of claim 7, wherein the storing comprises storing the base content and the portion of the additional information on a portable-computer-readable storage medium.

11. The method of claim 7, further comprising employing optical character recognition on the base content to generate a textual representation of the base content.

12. The method of claim 7, wherein the searching the set of resources includes searching a knowledge base based on the semantics to determine the set of resources.

13. The method of claim 7, wherein the receiving the base content includes receiving the base content as input written to a white board device.

14. An apparatus, comprising:
an interface configured to receive first input and to display output based on the first input;
a capture component configured to capture the output displayed by the apparatus and to store the output as base content on a first storage medium;
a knowledge retrieval component configured to analyze the base content to determine semantics of the base content and to search a set of resources based on the semantics of the base content to identify additional information, from the set of resources, related to the base content; and
an input device configured to receive second input related to a selection of a portion of the additional information,
wherein the interface is configured to convey the base content and the additional information related to the base content, and the capture component is further configured to automatically incorporate the portion of the additional information into the base content and to store the base content, with the portion of the additional information incorporated, on a second storage medium.

15. The apparatus of claim 14, wherein the second storage medium is removably coupled to the apparatus.

16. The apparatus of claim 14, wherein the interface comprise an interface configured to receive, as the first input, hand-written input.

17. The apparatus of claim 14, wherein the set of resources includes at least one of web pages, graphical images, text documents, audio streams, or video streams.

18. The apparatus of claim 14, wherein the apparatus further comprises a filter component configured to extract a subset of information, from the base content and the additional information incorporated into the base content, for storage on the second storage medium.

19. The apparatus of claim 18, wherein the filter component is further configured to extract the subset of information based on at least one of a user role or a type of information.

20. The apparatus of claim 16, wherein the knowledge retrieval component is further configured to employ optical character recognition on the hand-written input to generate a textual representation of the base content.
